(19) United States
(12) Patent Application Publication
(10) Pub. No.: US 2023/0226386 A1
(43) Pub. Date: Jul. 20, 2023

(54) Student Enclosure Assembly

(71) Applicant: Tanzie Crawford, Westchester, IL (US)

(72) Inventor: Tanzie Crawford, Westchester, IL (US)

(21) Appl. No.: 17/578,577

(22) Filed: Jan. 19, 2022

(51) Int. Cl. A62B 31/00; A47B 39/12; A61G 10/00

(52) U.S. Cl. CPC A62B 31/00; A47B 39/12; A61G 10/005; A47B 2200/0084; H04R 3/00

(57) ABSTRACT

A student enclosure assembly for protecting an individual from airborne pathogens includes an enclosure that is comprised of a fluid impermeable material to protect an occupant from pathogens. The enclosure has a plurality of air holes each extending through the enclosure to pass air into the enclosure. A plurality of filters is each integrated into the enclosure to filter pathogens from the air passing through the air holes. A pair of doors is each hingedly coupled to the enclosure for opening and closing the enclosure. A desk is positioned within the enclosure such that the desk is accessible to the user. A bench is positioned within the enclosure and the occupant can sit on the bench.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to enclosure devices and more particularly pertains to a new enclosure device for protecting an individual from airborne pathogens. The device includes an enclosure, a desk positioned in the enclosure and a bench positioned in the enclosure. The enclosure has air holes and filters that are aligned with the air holes for filtering airborne pathogens from the air. In this way a student can attend a class, for example, while being protected from airborne pathogens.

### (2) Description of Related Art Including Information Disclosed Under 37 CFR 1.97 and 1.98

The prior art relates to enclosure devices including a variety of safety enclosures for facilitating a clean environment to house an occupant. The prior art discloses a treatment booth that includes air filters and ultraviolet lamps for eliminating hazardous airborne particles. The prior art discloses a variety of enclosures that includes climate control for maintaining an interior of the enclosure at a pre-determined set of conditions. The prior art discloses an ornamental design for a privacy pod that includes a door.

### BRIEF SUMMARY OF THE INVENTION

An embodiment of the disclosure meets the needs presented above by generally comprising an enclosure that is comprised of a fluid impermeable material to protect an occupant from pathogens. The enclosure has a plurality of air holes each extending through the enclosure to pass air into the enclosure. A plurality of filters is each integrated into the enclosure to filter pathogens from the air passing through the air holes. A pair of doors is each hingedly coupled to the enclosure for opening and closing the enclosure. A desk is positioned within the enclosure such that the desk is accessible to the user. A bench is positioned within the enclosure and the occupant can sit on the bench.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a back perspective view of a student enclosure assembly according to an embodiment of the disclosure.

FIG. 2 is a front perspective view of an embodiment of the disclosure.

FIG. 3 is a left side view of an embodiment of the disclosure.

### DETAILED DESCRIPTION OF THE INVENTION

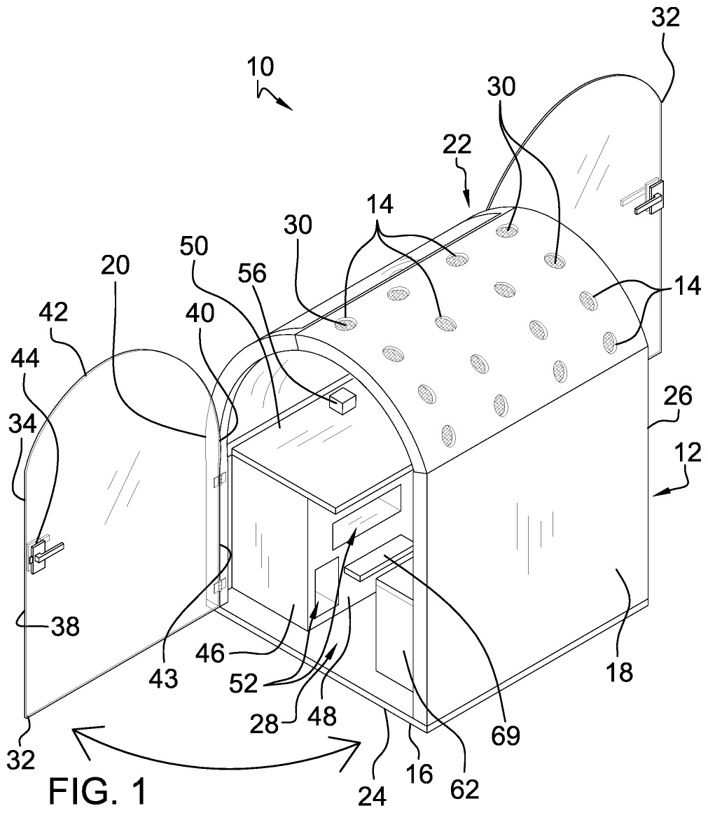

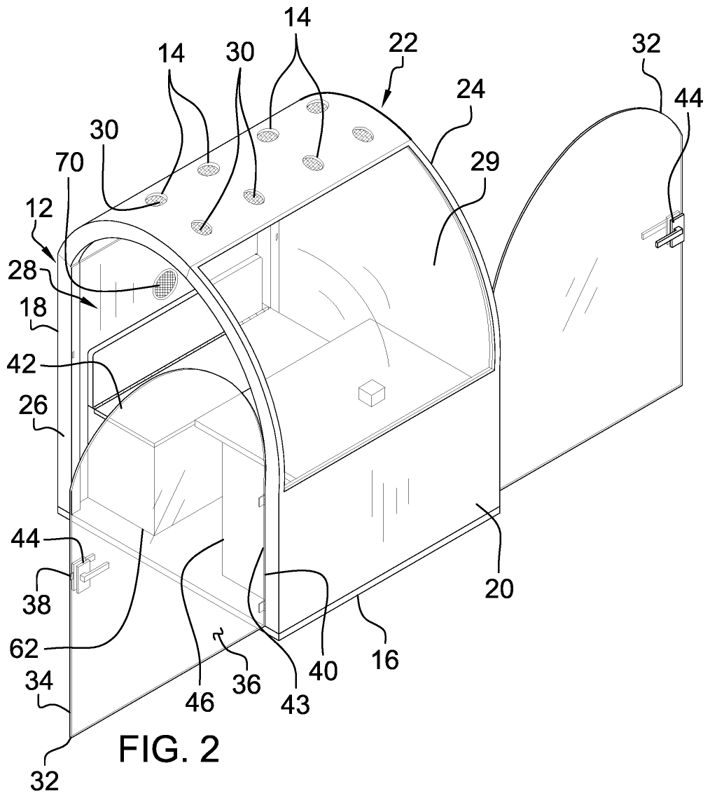

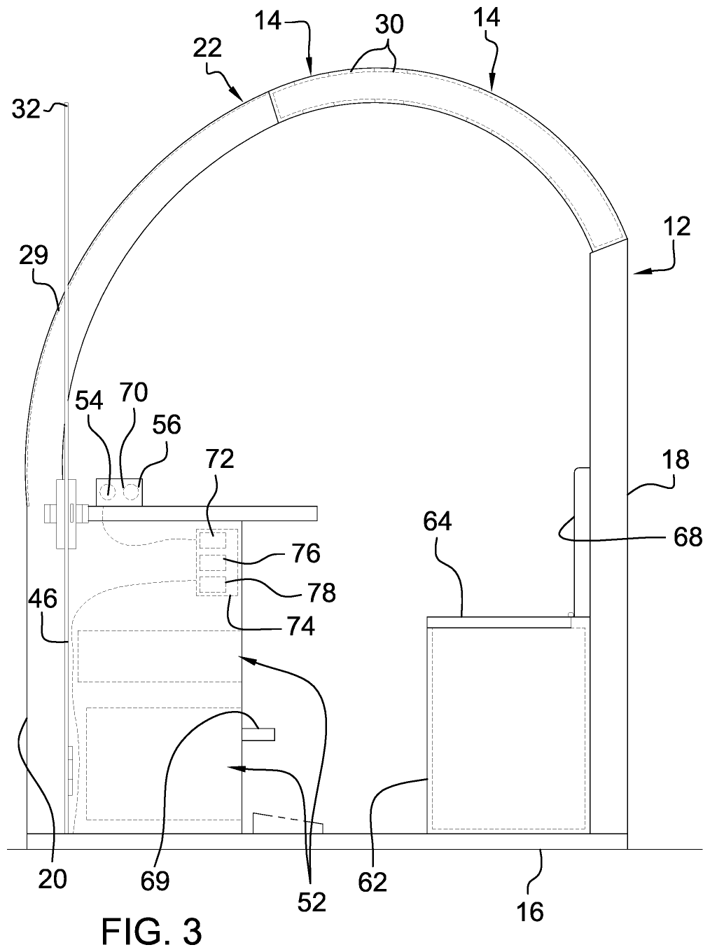

With reference now to the drawings, and in particular to FIGS. 1 through 3 thereof, a new enclosure device embodying the principles and concepts of an embodiment of the disclosure and generally designated by the reference numeral 10 will be described.

As best illustrated in FIGS. 1 through 3, the student enclosure assembly 10 generally comprises an enclosure 12 that is comprised of a fluid impermeable material to protect an occupant from pathogens. The occupant may be a student in an elementary school and the enclosure 12 may be positioned in a classroom in the elementary school. The enclosure 12 has a plurality of air holes 14 each extending through the enclosure 12 to pass air into the enclosure 12. The enclosure 12 has a basal wall 16, a rear wall 18 and front wall 20, and the front wall 20 curves rearwardly to intersect the rear wall 18 such that the front wall 20 defines an arched roof 22 of the enclosure 12. The enclosure 12 has a first sidelong side 24 and a second sidelong side 26, and each of the first sidelong side 24 and the second sidelong side 26 is open to define a pair of entries 28 into the enclosure 12 to facilitate the occupant to enter and exit the enclosure 12. Additionally, the enclosure 12 may be manufactured in a variety of dimensions for accommodating occupants ranging between elementary school students and college students.

Each of the air holes 14 extends through the arched roof 22. Furthermore, the air holes 14 are spaced apart from each other and are distributed between the first lateral side 24 and the second lateral side 26 of the enclosure 12. The front wall 20 has a window 29 extending through the front wall 20 to facilitate the occupant to see through the window 29. The window 29 is comprised of a translucent material thereby facilitating the occupant to see through the window 29 while inhibiting pathogens from passing through the window 29.

A plurality of filters 30 is provided and each of the filters 30 is integrated into the enclosure 12. Each of the filters 30 is aligned with a respective one of the air holes 14 for filtering pathogens from the air passing through the air holes 14. Additionally, each of the filters 30 is integrated into the arched roof 22 of the enclosure 12. The plurality of filters 30 may each comprise a high efficiency particulate air filter or other type of filter which can capture any airborne particle with a size of 0.3 microns or greater.

A pair of doors 32 is provided and each of the doors 32 is hingedly coupled to the enclosure 12 for opening and closing the enclosure 12. Each of the doors 32 has a perimeter edge 34 and a first surface 36, and the perimeter edge 34 has a first lateral side 38, a second lateral side 40 and a top side 42. The top side 42 curves upwardly between the first lateral side 38 and the second lateral side 40, and the first lateral side 38 has a height that is greater than a height of the second lateral side 40. The second lateral side 40 of the perimeter edge 34 of each of the doors 32 is hingedly coupled to a bounding edge 43 of a respective one of the entries 28 defined on the first sidelong side 24 and the second sidelong side 26 of the enclosure 12. Furthermore, the top side 42 of the perimeter edge 34 of each of the door conforms to curvature of the arched roof 22 of the enclosure 12 when the doors 32 are closed. Each of the doors 32 is comprised of a translucent material thereby facilitating the occupant to see through the doors 32.

A pair of latches 44 is each coupled the first surface 36 of a respective one of the doors 32. Each of the latches 44 extends outwardly beyond the first lateral side 24 of the perimeter edge 34 of the respective door 32. Additionally, each of the latches 44 releasably engages the rear wall 18 of the enclosure 12 when the respective door 32 is closed for retaining the respective door 32 in a closed position.

A desk 46 is positioned within the enclosure 12 such that the desk 46 is accessible to the user, and the desk 46 is positioned against the front wall 20 of the enclosure 12. The desk 46 has a back side 48 and a top side 50, and the back side 48 has a plurality of storage wells 52 each is recessed into the back side 48 for storing objects. A microphone 54 is provided and the microphone 54 is coupled to the desk 46 to capture audible sounds. The microphone 54 may be an electronic microphone that is a component of an intercom box 56, for example, that is positioned within the enclosure 12.

A bench 62 is positioned within the enclosure 12 such that the bench 62 can be sat upon by the occupant. The bench 62 is positioned against the rear wall 18 of the enclosure 12 and the bench 62 has a lid 64 which is hingedly positioned on the bench 62.

The bench 62 is substantially hollow for storing objects. The lid 64 is positionable in a closed position to facilitate the occupant to sit on the lid 64. The lid 64 might include a cushion 66 that is positioned on top of the lid 64 for enhancing comfort for the occupant. A back rest 68 is coupled to the rear wall 18 of the enclosure 12 and the back rest 68 is positioned inside of the enclosure 12. The back rest 68 is aligned with the bench 62 to facilitate the occupant to lean against the back rest 68, and the back rest 68 might including a cushion 67 to enhance comfort for the user. A footrest 69 is integrated into the desk 46 and the footrest 69 is spaced from the basal wall 16 of the enclosure 12 to facilitate the occupant to rest their feet on the footrest 69.

A speaker 70 is integrated into the desk 46 to emit sounds outwardly from the speaker 70, the speaker 70 is in electrical communication with the microphone 54 and the speaker may be integrated into the intercom box 56. The speaker 70 may comprise an electronic speaker of any conventional design. An amplifier circuit 72 is provided and the amplifier circuit 72 is integrated into the desk 46. The amplifier circuit 72 is electrically coupled between the microphone 54 and the speaker 70 for amplifying an audio signal sent from the microphone 54 to the speaker 70. The intercom box 56 may include an earphone port 73 to facilitate earphones worn by the user to be plugged into the earphone port 73 to facilitate the to communicate with the earphones.

A power supply 74 is integrated into the desk 46 and the power supply 74 is electrically coupled to the amplifier circuit 72. The power supply 74 comprises a power port 76 that is recessed into the desk 46. An electronic device, such as a smart phone or the like, can be plugged into the power port 76 for charging the electronic device. The power port 76 may comprise a universal serial bus port or other conventional type of charge port. The power supply 74 includes a rechargeable battery 78 that is integrated into the desk 46, and the rechargeable battery 78 is electrically coupled to the power port 76.

In use, the occupant enters the enclosure 12 and the occupant closes each of the doors 32. In this way the occupant is protected from pathogens while the occupant attends class, for example, or other event that involves multiple participants. Furthermore, the desk 46 and the bench 62 facilitate the occupant to perform tasks that are commonly performed during classroom instruction. The microphone 54 and the speaker 70 facilitate the occupant to verbally communicate with individuals outside of the enclosure 12. Additionally, the occupant can charge electronic devices with the charge port in the desk 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A student enclosure assembly for facilitating a student to attend a classroom while being protected from pathogens, said assembly comprising:
an enclosure being comprised of a fluid impermeable material wherein said enclosure is configured to protect an occupant from pathogens, said enclosure having a plurality of air holes each extending through said enclosure wherein each of said air holes is configured to pass air into said enclosure;
a plurality of filters, each of said filters being integrated into said enclosure, each of said filters being aligned with a respective one of said air holes wherein each of said filters is configured to filter pathogens from the air passing through said air holes;
a pair of doors, each of said doors being hingedly coupled to said enclosure for opening and closing said enclosure;
a desk being positioned within said enclosure wherein said desk is configured to be accessible to the user;
a microphone being coupled to said desk wherein said microphone is configured to capture audible sounds;
a bench being positioned within said enclosure wherein said bench is configured to be sat upon by the occupant; and
a speaker being integrated into said enclosure wherein said speaker is configured to emit sounds outwardly from said speaker.

2. The assembly according to claim 1, wherein:
said enclosure has a basal wall, a rear wall and front wall, said front wall curving rearwardly to intersect said rear wall such that said front wall defines an arched roof of said enclosure, said enclosure having a first lateral side and a second lateral side, each of said first lateral side and said second lateral side being open to define a pair of entries into said enclosure wherein said entries are configured to facilitate the occupant to enter and exit said enclosure;
each of said air holes extends through said arched roof, said air holes being spaced apart from each other and being distributed between said first lateral side and said second lateral side of said enclosure; and
said front wall has a window extending through said front wall wherein said window is configured to facilitate the occupant to see through said window.

3. The assembly according to claim 2, wherein each of said doors has a perimeter edge and a first surface, said perimeter edge having a first lateral side, a second lateral side and a top side, said top side curving upwardly between said first lateral side and said second lateral side, said first lateral side having a height being greater than a height of said second lateral side, said second lateral side of said perimeter edge of each of said doors being hingedly coupled to a bounding edge of a respective one of said entries defined on said first lateral side and said second lateral side of said enclosure, said top side of each of said door conforming to curvature of said arched roof of said enclosure when said doors are closed.

4. The assembly according to claim 3, further comprising a pair of latches, each of said latches being coupled said first surface of a respective one of said doors, each of said latches extending outwardly beyond said first lateral side of said perimeter edge of said respective door, each of said latches releasably engaging said rear wall of said enclosure when said respective door is closed for retaining said respective door in a closed position.

5. The assembly according to claim 2, wherein said desk is positioned against said front wall of said enclosure, said desk having a back side and a top side, said back side having a plurality of storage wells each being recessed into said back side wherein each of said storage wells is configured to store objects.

6. The assembly according to claim 2, wherein:
said bench is positioned against said rear wall of said enclosure, said bench having a lid being hingedly positioned on said bench, said bench being substantially hollow wherein said bench is configured to store objects, said lid being positionable in a closed position wherein said lid is configured to have the occupant sit on said lid; and
said assembly includes a back rest being coupled to said rear wall of said enclosure, said back rest being positioned inside of said enclosure, said back rest being aligned with said bench wherein said back rest is configured to facilitate the occupant to lean against said back rest.

7. The assembly according to claim 1, wherein:
said speaker is in electrical communication with said microphone; and
said assembly includes an amplifier circuit being integrated into said desk, said amplifier circuit being electrically coupled between said microphone and said speaker for amplifying an audio signal sent from said microphone to said speaker.

8. The assembly according to claim 7, further comprising a power supply being integrated into said desk, said power supply being electrically coupled to said amplifier circuit, said power supply comprising:
a power port being recessed into said desk wherein said power port is configured to have an electronic device plugged into said power port for charging the electronic device; and
a rechargeable battery being integrated into said desk, said rechargeable battery being electrically coupled to said power port.

9. A student enclosure assembly for facilitating a student to attend a classroom while being protected from pathogens, said assembly comprising:
an enclosure being comprised of a fluid impermeable material wherein said enclosure is configured to protect an occupant from pathogens, said enclosure having a plurality of air holes each extending through said enclosure wherein each of said air holes is configured to pass air into said enclosure, said enclosure having a basal wall, a rear wall and front wall, said front wall curving rearwardly to intersect said rear wall such that said front wall defines an arched roof of said enclosure, said enclosure having a first lateral side and a second lateral side, each of said first lateral side and said second lateral side being open to define a pair of entries into said enclosure wherein said entries are configured to facilitate the occupant to enter and exit said enclosure, each of said air holes extending through said arched roof, said air holes being spaced apart from each other and being distributed between said first lateral side and said second lateral side of said enclosure, said front wall having a window extending through said front wall wherein said window is configured to facilitate the occupant to see through said window;
a plurality of filters, each of said filters being integrated into said enclosure, each of said filters being aligned with a respective one of said air holes wherein each of said filters is configured to filter pathogens from the air passing through said air holes, each of said filters being integrated into said arched roof of said enclosure;
a pair of doors, each of said doors being hingedly coupled to said enclosure for opening and closing said enclosure, each of said doors having a perimeter edge and a first surface, said perimeter edge having a first lateral side, a second lateral side and a top side, said top side curving upwardly between said first lateral side and said second lateral side, said first lateral side having a height being greater than a height of said second lateral side, said second lateral side of said perimeter edge of each of said doors being hingedly coupled to a bounding edge of a respective one of said entries defined on said first lateral side and said second lateral side of said enclosure, said top side of each of said door conforming to curvature of said arched roof of said enclosure when said doors are closed;
a pair of latches, each of said latches being coupled said first surface of a respective one of said doors, each of said latches extending outwardly beyond said first lateral side of said perimeter edge of said respective door, each of said latches releasably engaging said rear wall of said enclosure when said respective door is closed for retaining said respective door in a closed position;
a desk being positioned within said enclosure wherein said desk is configured to be accessible to the user, said desk being positioned against said front wall of said enclosure, said desk having a back side and a top side, said back side having a plurality of storage wells each being recessed into said back side wherein each of said storage wells is configured to store objects;
a microphone being coupled to said desk wherein said microphone is configured to capture audible sounds;
a bench being positioned within said enclosure wherein said bench is configured to be sat upon by the occupant, said bench being positioned against said rear wall of said enclosure, said bench having a lid being hingedly positioned on said bench, said bench being substantially hollow wherein said bench is configured to store objects, said lid being positionable in a closed position wherein said lid is configured to have the occupant sit on said lid;
a back rest being coupled to said rear wall of said enclosure, said back rest being positioned inside of said enclosure, said back rest being aligned with said bench wherein said back rest is configured to facilitate the occupant to lean against said back rest;
a speaker being integrated into said enclosure wherein said speaker is configured to emit sounds outwardly from said speaker, said speaker being in electrical communication with said microphone;
an amplifier circuit being integrated into said desk, said amplifier circuit being electrically coupled between said microphone and said speaker for amplifying an audio signal sent from said microphone to said speaker; and
a power supply being integrated into said desk, said power supply being electrically coupled to said amplifier circuit, said power supply comprising:
a power port being recessed into said desk wherein said power port is configured to have an electronic device plugged into said power port for charging the electronic device; and
a rechargeable battery being integrated into said desk, said rechargeable battery being electrically coupled to said power port.
